(19) United States
(12) Patent Application Publication
(10) Pub. No.: US 2007/0079313 A1
(43) Pub. Date: Apr. 5, 2007

(54) Information processing apparatus and control method thereof

(76) Inventor: Takashi Sakurai, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/528,301

(22) Filed: Sep. 26, 2006

(30) Foreign Application Priority Data
Sep. 30, 2005 (JP) P2005-288382

(51) Int. Cl. G11B 33/14

(52) U.S. Cl. 720/649

(57) ABSTRACT

According to one embodiment, an information processing apparatus includes: a fan; a measurement unit which measures sound volume produced by the fan; a data processing unit which processes data while performing at least one playback quality improvement process; and a control unit which controls execution of each of the at least one playback quality improvement process based on the sound volume measured by the measurement unit.

### CROSS-REFERENCE TO RELATED APPLICATIONS

This application is based upon and claims the benefit of priority from Japanese Patent Application No. 2005-288382, filed on Sep. 30, 2005, the entire contents of which are incorporated herein by reference.

### BACKGROUND

1. Field

One embodiment of the invention relates to an information processing apparatus and control method thereof.

2. Description of the Related Art

It has been a common that a portable personal computer has a function of playing back moving image data such a movie recorded on, e.g., a DVD (digital versatile disk), with improvement in the image processing technology in recent years.

This kind of personal computer has a fan for cooling a CPU and a power supply circuit is placed in a case of the computer. On the other hand, there is also a user demand for keeping silence when listening to music. Thus, for example, an electronic device is proposed in Japanese Patent Application Publication No. 2003-076444, wherein when a specific application program such as a music player for playing back music data recorded on a CD (Compact Disk) is started, the rotation speed of a fan is automatically decreased for suppressing noise occurrence.

The load imposed on the CPU and the power supply circuit is markedly large and the heating value also increases to play back video data containing music data, as compared with playing back music data only. Therefore, it is not appropriate to apply the simple control technique of automatically decreasing the rotation speed of the fan when a specific application program for playing back video data is started. Which of silence and high image quality having the tradeoff relation is to be assigned a higher priority varies from one user to another and thus it is also necessary to meet each user demand.

### BRIEF DESCRIPTION OF THE SEVERAL VIEWS OF THE DRAWINGS

FIG. 1 is an exemplary block diagram to show the system configuration of an information processing apparatus according to one embodiment of the invention;

FIG. 2 is an exemplary block diagram of software to describe the operation principle of a fan sound control utility program executed in the information processing apparatus of the embodiment;

FIG. 3 is an exemplary diagram to show an example of a setting screen displayed for a user interface by the fan sound control utility program executed in the information processing apparatus of the embodiment;

FIG. 4 is an exemplary diagram to show the function names of image quality improvement modules with priority level to stop the function in a content playback application program executed in the information processing apparatus of the embodiment; and

FIG. 5 is an exemplary flowchart to show the operation procedure of the fan sound control utility program executed in the information processing apparatus of the embodiment.

### DETAILED DESCRIPTION

Various embodiments according to the invention will be described hereinafter with reference to the accompanying drawings.

In general, according to one embodiment of the invention, there is provided an information processing apparatus including: a fan; a measurement unit which measures sound volume produced by the fan; a data processing unit which processes data while performing at least one playback quality improvement process; and a control unit which controls execution of each of the at least one playback quality improvement process based on the sound volume measured by the measurement unit.

Further, according to one embodiment of the invention, there is provided a control method of an information processing apparatus including a fan and a data processing unit which processes data while performing at least one playback quality improvement process, the control method comprising: measuring sound volume produced by the fan; and controlling execution of each of the at least one playback quality improvement process based on the measured sound volume.

As described above, according to one embodiment of the invention, there is provided an information processing apparatus and a control method of the information processing apparatus which dynamically controls the playback quality improvement function thereby realizing silence at the level requested by the user.

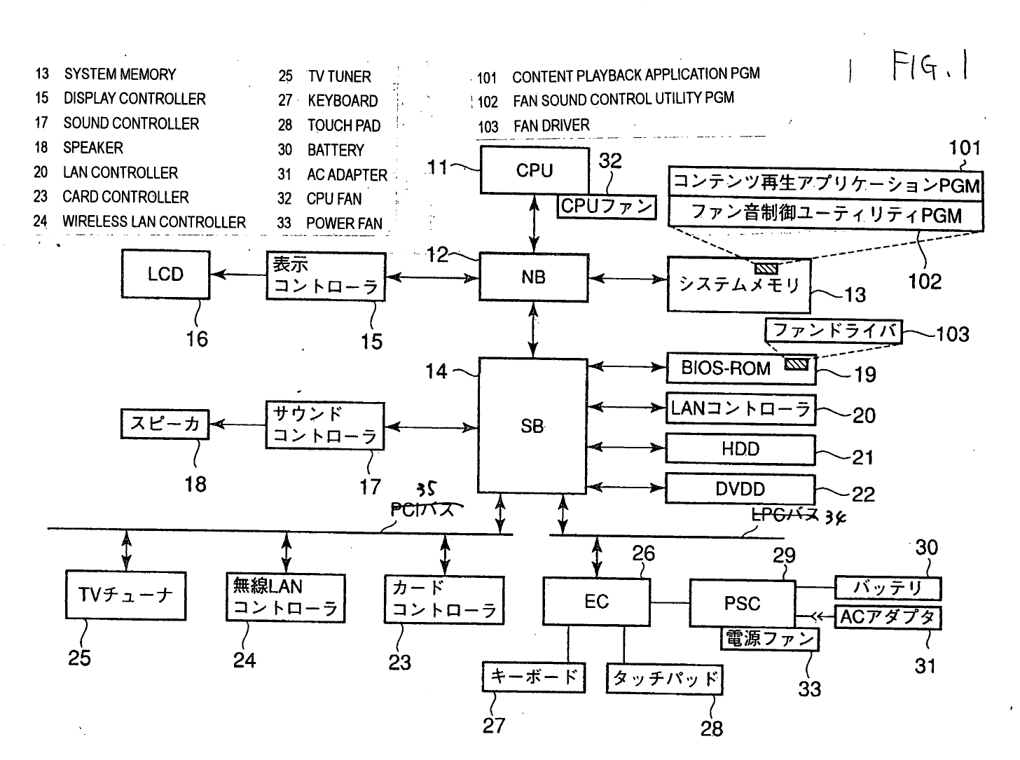

FIG. 1 is an exemplary diagram to show the system configuration of an information processing apparatus according to one embodiment of the invention. In this embodiment, the information processing apparatus is, for example, implemented as a computer such as notebook personal computer.

The computer includes a CPU 11, a north bridge (NB) 12, system memory 13, a south bridge (SB) 14, a display controller 15, an LCD 16, a sound controller 17, a speaker 18, BIOS-ROM 19, a LAN controller 20, a hard disk drive (HDD) 21, a DVD drive (DVDD) 22, a card controller 23, a wireless LAN controller 24, a TV tuner 25, an embedded controller IC (EC) 26, a keyboard 27, a touch pad 28, a power supply circuit (PSC) 29, a battery 30, and an AC adapter 31, as shown in FIG. 1. The computer is provided with two fans of a CPU fan 32 for cooling the CPU 11 and a power fan 33 for cooling the PSC 29.

The CPU 11 is a processor to control the operation of the computer and executes an operating system and various application programs such as a content playback application program (content playback application PGM) 101 and a fan sound control utility program (fan sound control utility PGM) 102 described later loaded into the system memory 13 from the HDD 21 and the DVDD 22. The CPU 11 also executes system BIOS (Basic Input/Output System) stored in the BIOS-ROM 19. The system BIOS is a hardware control program. It contains a fan driver 103 to perform drive control of the CPU fan 32 and the power fan 33.

The NB 12 is a bridge device to connect a local bus of the CPU 11 and the SB 14. The NB 12 also contains a memory controller to control access to the system memory 13. The NB 12 also has a function of executing communications with the display controller 15 through an AGP (Accelerated Graphics Port) bus, a serial bus of PCI express standard, etc.

The display controller 15 is a controller to control the LCD 16 used as the display monitor of the computer. The content playback application program 101 performs various types of image improvement processing to provide high image quality for the video data supplied to the display controller 15.

The SB 14 controls devices on an LPC (Low Pin Count) bus 34 and devices on a PCI (Peripheral Component Interconnect) bus 35. The SB 14 also contains an IDE (Integrated Drive Electronics) controller to control the HDD 21 and the DVDD 22. Further, the SB 14 also has a function of executing communications with the sound controller 17.

The sound controller 17 is a sound source device and outputs audio data to be played back to the speaker 18. The content playback application program 101 also performs various types of sound improvement processing to provide high sound quality for the audio data supplied to the sound controller 17.

The card controller 23 controls cards such as a PC card and an SD (Secure Digital) card. The wireless LAN controller 24 is a wireless communication device to execute wireless communications of IEEE 802.11 standard, for example. The TV tuner 25 is a tuning circuit to input TV broadcast data on any desired channel through a TV antenna terminal. The TV broadcast data input by the TV tuner 25 is processed by the content playback application program 101. The content playback application program 101 performs image processing containing image quality improvement process to provide high image quality for video data. The content playback application program 101 also performs audio processing containing sound quality improvement process to provide high sound quality for audio data. Then, the video data and the audio data are supplied to the display controller 15 and the sound controller 17 respectively for output.

The EC 26 includes a one-chip microcomputer containing a keyboard controller to control the keyboard 27 and the touch pad 28. The PSC 29 controls the power supply of the computer in a unified manner; it controls the power supply from the battery 30 or the AC adapter 31 to the components.

In the described computer, the fan sound control utility program 102 dynamically controls the playback quality improvement function included in the content playback application program 101. The playback quality improvement function contains image quality improvement function and sound quality improvement function. The control of this function can suppress noise produced by the CPU fan 32 and the power fan 33 to the user-required level or less at the operation time of the content playback application program 101. The operation of the content playback application program 101 gives large load to the CPU 11 and the PSC29 and easily heating them, namely, readily operating the CPU fan 32 and the power fan 33. The operation principle of the fan sound control utility program 102 will be discussed below in detail.

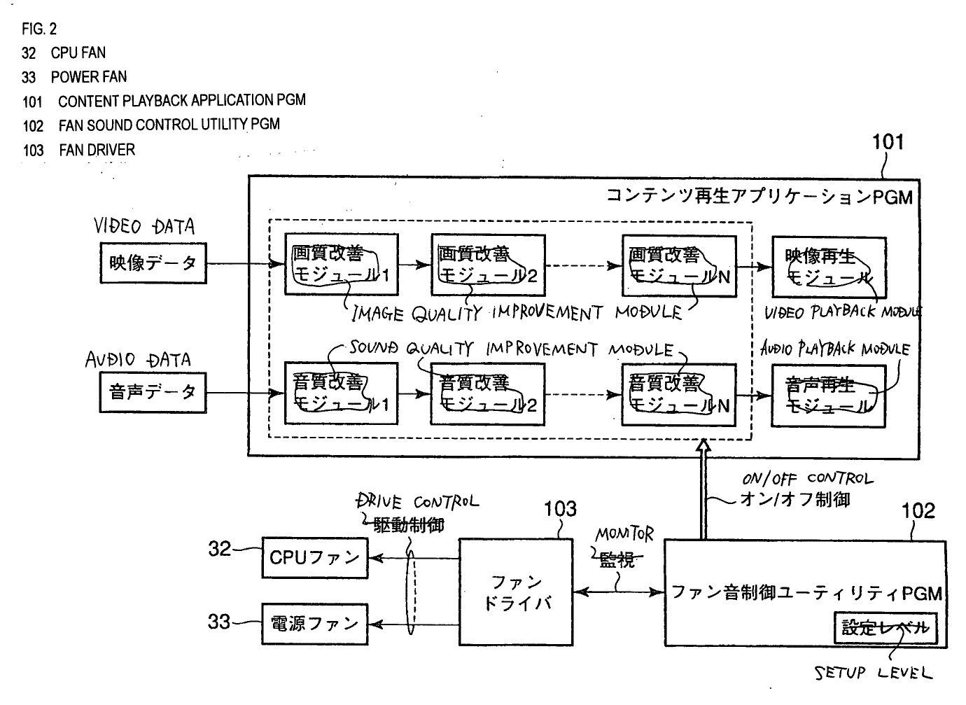

FIG. 2 is an exemplary block diagram of software to show the operation principle of the fan sound control utility program 102.

The content playback application program 101 has a video playback module to play back video data and a plurality of image quality improvement modules to execute image quality improvement processing as preprocessing of the video playback processing performed by the video playback module. The content playback application program 101 also has an audio playback module to play back audio data and a plurality of sound quality improvement modules to execute sound quality improvement processing as preprocessing of the audio playback processing performed by the audio playback module. The contents playback application program 101 may includes at least one image quality improvement module and/or at least one sound quality improvement module.

On the other hand, the fan sound control utility program 102 monitors noise produced by the CPU fan 32 and the power fan 33 through the fan driver 103 to perform drive control of the CPU fan 32 and the power fan 33. To monitor the noise, for example, the rotation speed of the CPU fan 32 and that of the power fan 33 are acquired from the fan driver 103 and whether or not the noise total measured from the acquired rotation speeds is within a predetermined setup level is checked.

If the measured noise is about to exceed the setup level, the fan sound control utility program 102 stops the image quality improvement modules and the sound quality improvement modules of the content playback application program 101 in stages, thereby lightening the loads on the CPU 11 and the PSC 29 so as not to increase the rotation speeds of the CPU fan 32 and the power fan 33.

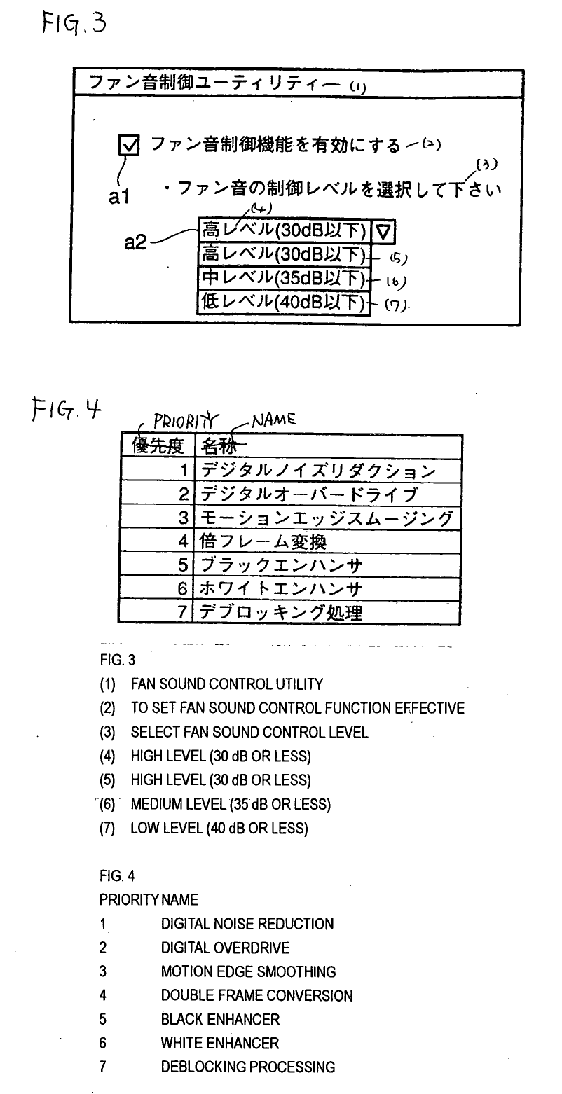

FIG. 3 is an exemplary diagram to show an example of a setting screen displayed for a user interface by the fan sound control utility program 102.

The setting screen first enables the user to set effectiveness/ineffectiveness of the fan sound control function of the fan sound control utility program 102. If the user checks a check box a1 in the screen, the fan sound control function is set effective. If the user sets the fan sound control function ineffective, the image quality improvement modules and the sound quality improvement modules of the content playback application program 101 are not stopped regardless of the magnitude of noise produced by the CPU fan 32 and the power fan 33.

On the other hand, if the user checks the check box a1 to set the fan sound control function effective, the setting screen second enables the user to select the fan sound control level. The control level is set, for example, as the user selects any of high level (30 dB or less), medium level (35 dB or less), or low level (40 dB or less) out of a menu box a2. For example, if the user sets the high level, whenever noise produced by the CPU fan 32 and the power fan 33 is about to reach 30 dB, the image quality improvement modules and the sound quality improvement modules of the content playback application program 101 start to stop in stages. The settings of the setting screen are retained by the fan sound control utility program 102.

FIG. 4 is an exemplary diagram to show the function names of image quality improvement modules with priority level to stop the function in a content playback application program 101.

Now, assume that the user sets the fan sound control function of the fan sound control utility program 102 effective and sets the control level to the high level. Then, when the noise level measured from the rotation speeds of the CPU fan 32 and the power fan 33 acquired from the fan driver 103 is about to reach 30 dB, the fan sound control utility program 102 first turns off “digital noise reduction.” If the noise level is about to reach 30 dB still after the “digital noise reduction” is turned off, then the fan sound control utility program 102 turns off “digital overdrive.”

Likewise, the fan sound control utility program 102 turns off the image quality improvement modules in the order of “motion edge smoothing,” “double frame conversion,” “black enhancer,” “white enhancer,” and “deblocking processing.” The effects of the functions of the image quality improvement modules are as follows.

(1) “Digital noise reduction” reduces roughness.

(2) “Digital overdrive” decreases sense of persistence of vision of video fast in motion.

(3) “Motion edge smoothing” decreases jaggies of contours.

(4) “Double frame conversion” converts usual 30-frame video into 60-frame video for playback.

(5) “Black enhancer” executes conversion to display black clearly.

(6) “White enhancer” executes conversion to display white clearly.

(7) “Deblocking processing” decreases macro block noise displayed when MPEG is played back.

Thus, the fan sound control utility program 102 dynamically controls the image quality improvement modules included in the content playback application program 101, thereby suppressing noise produced by the CPU fan 32 and the power fan 33 to the user-required level or less. The fan sound control utility program 102 also dynamically controls the sound quality improvement modules on a similar principle, thereby suppressing noise of the cooling fans to meet the user demand.

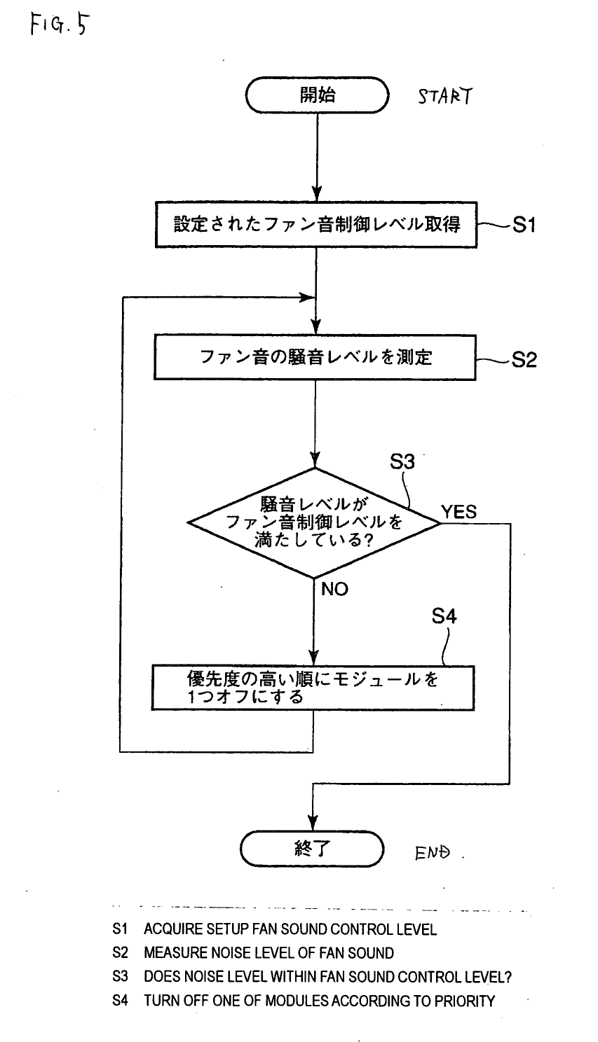

FIG. 5 is an exemplary flowchart to show the operation procedure of the fan sound control utility program 102.

The fan sound control utility program 102 first acquires the fan sound control level set by the user (block S1). Then, the fan sound control utility program 102 measures the noise level of the fan sound produced by the CPU fan 32 and the power fan 33 through the fan driver 103 (block S2) and checks whether or not the measured noise level is within the fan sound control level set by the user (block S3).

If the measured noise level is not within the fan sound control level (NO at block S3), the fan sound control utility program 102 turns off one of the modules according to the priority (block S4). The fan sound control utility program 102 repeats blocks S2 to S4 until the measured noise level falls within the fan sound control level set by the user (YES at block S3).

As described above, the image quality improvement function and the sound quality improvement function are controlled dynamically in the computer, whereby silence at the level required by the user is realized.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. An information processing apparatus comprising:
a fan;
a measurement unit which measures sound volume produced by the fan;
a data processing unit which processes data while performing at least one playback quality improvement process; and
a control unit which controls execution of each of the at least one playback quality improvement process based on the sound volume measured by the measurement unit.

2. The information processing apparatus according to claim 1, wherein the data processed by the data processing unit contains image data, and
wherein the at least one playback quality improvement process includes at least one image quality improvement process which improves an image played by processing the image data.

3. The information processing apparatus according to claim 1, wherein the data processed by the data processing unit contains audio data, and
wherein the at least one playback quality improvement process includes at least one sound quality improvement process which improves an image played by processing the image data.

4. The information processing apparatus according to claim 1, further comprising a setting unit which specifies the at least one playback quality improvement process of which the execution is controlled by the control unit.

5. The information processing apparatus according to claim 4, wherein the setting unit which specifies an allowable value of the sound volume produced by the fan, and
wherein the control unit controls the execution of each of the at least one playback quality improvement process to suppress the sound volume produced by the fan to the allowable value or less.

6. The information processing apparatus according to claim 1, wherein the fan includes a CPU fan to cool a CPU whose load fluctuates in response to the execution of each of the at least one playback quality improvement process.

7. The information processing apparatus according to claim 1, wherein the fan includes a power fan to cool a power supply circuit whose load fluctuates in response to the execution of each of the at least one playback quality improvement process.

8. The information processing apparatus according to claim 1, wherein the measurement unit acquires the rotation speed of the fan and measures the sound volume produced by the fan based on the acquired rotation speed.

9. A control method of an information processing apparatus including a fan and a data processing unit which processes data while performing at least one playback quality improvement process, the control method comprising:
measuring sound volume produced by the fan; and
controlling execution of each of the at least one playback quality improvement process based on the measured sound volume.
